(19) United States
(12) Patent Application Publication
(10) Pub. No.: US 2022/0108390 A1
(43) Pub. Date: Apr. 7, 2022

(54) SYSTEM AND METHOD FOR UTILIZING A MECHANIC'S LIEN FOR ENHANCING PAYMENT PERFORMANCE ON AN AGREEMENT

(71) Applicant: Billd, LLC, Austin, TX (US)

(72) Inventor: Christopher Lee Doyle, Austin, TX (US)

(21) Appl. No.: 17/492,176

(22) Filed: Oct. 1, 2021

Related U.S. Application Data
(60) Provisional application No. 63/086,242, filed on Oct. 1, 2020.

(51) Int. Cl. G06Q 40/02; G06Q 30/00

(52) U.S. Cl. CPC G06Q 40/025; G06Q 30/018

(57) ABSTRACT

A computer-implemented method for utilizing a mechanic's lien to enhance payment performance on a financial agreement, the method may include initiating a mechanic's lien process based on determining that a stakeholder is not in good standing (not in compliance with terms of the financial agreement), sending a first notification to the stakeholder, performing a first determination if the stakeholder is in good standing, and sending a notice of intent to lien to the stakeholder based on the first determination. Next, a second determination identifying whether the stakeholder is in good standing may be performed, this may result in a lien notification being sent to the stakeholder when the second determination identifies that the stakeholder is not in good standing. Then, after a third determination identifying that the stakeholder is still not incompliance a lien may be filed and a notification identifying that the lien has been filed may be sent.

### CROSS-REFERENCE TO RELATED APPLICATIONS

The present disclosure claims priority benefit of U.S. provisional patent application 63/086,242 filed on Oct. 1, 2020, the disclosure of which is incorporated by reference herein.

### BACKGROUND

### Field of the Disclosure

The present disclosure is generally related to a system and method for enhancing payment performance and particularly to a system and method for utilizing a mechanic's lien to enhance payment performance on an agreement.

### Description of the Related Art

Borrowers borrowing money to purchase a property apply for a loan agreement in one of several ways. For example, a borrower may apply through a lender, or an individual representing the lender or apply electronically. A conventional method of enhancing payment performance includes notifying a borrower of violation of payment obligation and warning of consequences if a payment obligation continues to fail. Further, the lender may report delinquencies to Credit Bureaus—negatively impacting the borrower's credit score and or, if secured, the lender can pursue foreclosure of the asset. However, these conventional methods are less than optimal because these methods too narrowly focus on the borrower or secured asset.

Further, sometimes it becomes quite time-consuming and labor-intensive to monitor deadlines for recording the mechanic's liens to commence a legal action to enforce the mechanic's liens against the borrower. Further, the time to file the legal action to foreclose upon a mechanic's lien is generally very short, and such a short time is frequently forgotten by the lender, resulting in having an unenforceable lien. In addition, the deadlines and statute of limitation deadlines are jurisdictional, resulting in difficulty in recording the deadlines and the statute of limitation.

Therefore, there is a need for a system and method that can focus on the borrower and secured assets by enhancing payment performance on an agreement. Numerous prior arts exist that discloses such a system and method for enhancing payment performance on the agreement. Further, some state laws provide a means to secure enhanced payment performance by recording mechanics' liens. However, numerous complicating factors still exist in securing such enhanced payment performance, such as but not limited to the reluctance of the lender to record the mechanic's liens against the borrower to maintain a good relationship with the stakeholder, even when a borrower account is past due. For example, a stakeholder could be a real-estate property owner, contractor, sub-contractor, retailer of materials, or other related party. Additionally, stakeholders could be outside the area of real estate and could be any owners of any property.

Thus, it can be seen that a need exists for an improved method and system for implementing enhancements to financial instruments for utilizing a mechanic's lien that can overcome all the aforementioned limitations and provide an efficient system and method for enhancing payment performance on the agreement.

### SUMMARY OF THE PRESENTLY CLAIMED INVENTION

The present disclosure is directed to apparatus, methods, and non-transitory computer-readable media that identify whether a stakeholder is in compliance with terms of a financial agreement. In a first embodiment, a presently claimed method may include the steps of comparing payment data with payment completed data to identify whether a financial agreement between a first entity and a stakeholder is being adhered to, identifying that the financial agreement has not been adhered to based on comparison of the payment data with the payment completed data indicating that the stakeholder has not adhered to a term of the financial agreement, and generating a first notification indicating that a status of the stakeholder is not in good standing to send to the stakeholder based on the identification that the financial agreement has not been adhered to, wherein the first notification is sent to the stakeholder informing the stakeholder that they are not in good standing. This method may also include the steps of performing an evaluation to indicating that the stakeholder is still not in good standing, and generating a second notification indicating that a lien will be applied according to the financial agreement based on the evaluation indicating that the stakeholder is still not in good standing. The second notification may them be sent indicating that the lean will be applied according to the financial agreement based on the evaluation indicating that the stakeholder is still not in good standing.

In a second embodiment, when the method is performed as a non-transitory computer-readable media a processor executing instructions out of a memory may perform the steps of comparing payment data with payment completed data to identify whether a financial agreement between a first entity and a stakeholder is being adhered to, identifying that the financial agreement has not been adhered to based on comparison of the payment data with the payment completed data indicating that the stakeholder has not adhered to a term of the financial agreement, and generating a first notification indicating that a status of the stakeholder is not in good standing to send to the stakeholder based on the identification that the financial agreement has not been adhered to, wherein the first notification is sent to the stakeholder informing the stakeholder that they are not in good standing. Here again, this method may also include the steps of performing an evaluation to indicating that the stakeholder is still not in good standing, and generating a second notification indicating that a lien will be applied according to the financial agreement based on the evaluation indicating that the stakeholder is still not in good standing. The second notification may them be sent indicating that the lean will be applied according to the financial agreement based on the evaluation indicating that the stakeholder is still not in good standing.

In a third embodiment a processor may execute instructions out of the memory to implement the presently claimed method. This may include comparing payment data with payment completed data to identify whether a financial agreement between a first entity and a stakeholder is being adhered to, identifying that the financial agreement has not been adhered to based on comparison of the payment data with the payment completed data indicating that the stakeholder has not adhered to a term of the financial agreement, and generating a first notification indicating that a status of the stakeholder is not in good standing to send to the stakeholder based on the identification that the financial agreement has not been adhered to, wherein the first notification is sent to the stakeholder informing the stakeholder that they are not in good standing. The processor may also execute instructions out of the memory to perform an evaluation to indicating that the stakeholder is still not in good standing, and generating a second notification indicating that a lien will be applied according to the financial agreement based on the evaluation indicating that the stakeholder is still not in good standing may be generated. The second notification may then be sent indicating that the lean will be applied according to the financial agreement based on the evaluation indicating that the stakeholder is still not in good standing.

### BRIEF DESCRIPTION OF THE DRAWINGS

FIG. 1 illustrates a diagram of a system for managing payment performance associated with a financial agreement.

FIG. 2 illustrates a block diagram of a computing device that communicates with a computer that tracks compliance with terms of a financial agreement.

FIG. 3 illustrates a flow chart showing a working method for utilizing the mechanic's lien to enhance payment performance on the agreement.

FIG. 4 illustrates a series of steps that may be performed by a computer that manages compliance with a financial agreement and that issues mechanics liens when stakeholder are not in compliance with their financial agreement.

### DETAILED DESCRIPTION

A computer-implemented method for utilizing a mechanic's lien to enhance payment performance on a financial agreement, the method may include initiating a mechanic's lien process based on determining that a stakeholder is not in good standing (not in compliance with terms of the financial agreement), sending a first notification to the stakeholder, performing a first determination if the stakeholder is in good standing, and sending a notice of intent to lien to the stakeholder based on the first determination. Next, a second determination identifying whether the stakeholder is in good standing may be performed, this may result in a lien notification being sent to the stakeholder when the second determination identifies that the stakeholder is not in good standing. Then, after a third determination identifying that the stakeholder is still not incompliance a lien may be filed and a notification identifying that the lien has been filed may be sent to the stakeholder.

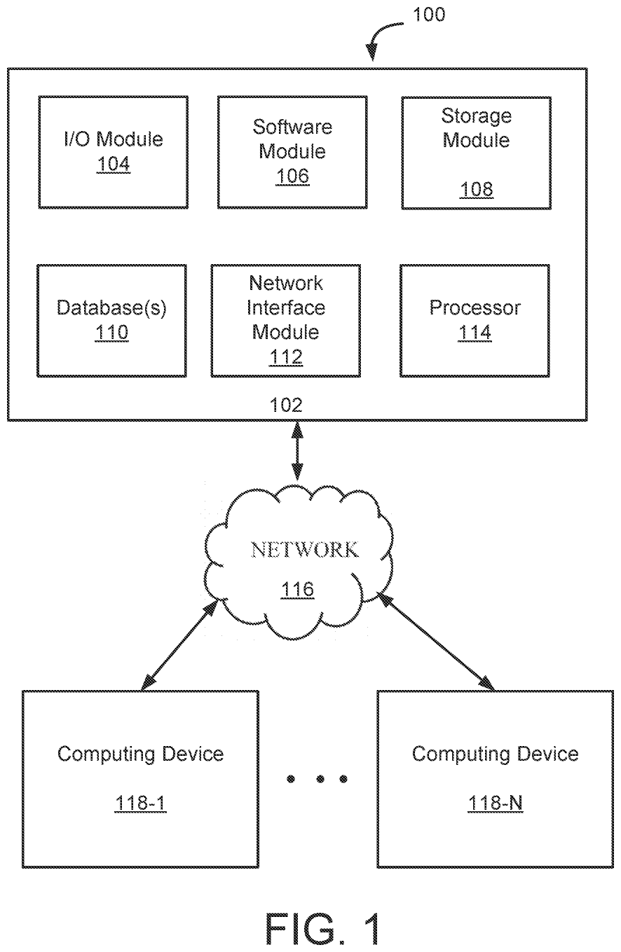

FIG. 1 illustrates a diagram of a system for managing payment performance associated with a financial agreement. The system 100 for utilizing a mechanic's lien for implementing an enhancement may be fully integrated for use with any additional platform and data output that may be used to communicate with other platforms, such as financial institution platforms, user information platforms, and cyber security and payment collection platforms. The system 100 may comprise a processing system 102. The processing system 102 may be configured to perform a method for enhancing payment performance on the agreement.

The processing system 102 may include an input/output (I/O) module 104, a software module 106, a storage module 108, one or more databases 110, a network interface module 112, and a processor 114. The I/O module 104 may enable a system administrator to provide specialized access of the system 100 to its users. The I/O module 104 may provide access to either input or output or both input and output in the system 100. The users can perform input or output in the system 100 using input or output devices or a user interface of a user device. The input device may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output device may include video displays, graphical displays, speakers, headphones, inkjet printers, laser printers, and 3D printers.

The system 100 for implementing an enhancement may operate as application software that may be managed by a local or remote computing device. The software module 106 is a software component or part of a program that contains one or more routines. Further, the software module 106 may include one or more independently developed modules or set of instructions that enhance a financial instrument. The software module 106 may partition the system design or program or code in whole programs or applications software libraries and classes. In one embodiment, the software module 106 may include a software framework or architecture that optimizes ease of use of at least one existing software platform and may extend the capabilities of at least one existing software platform. The software architecture may approximate the actual way a user organizes and manages electronic files. This may allow a user to organize use activities in a natural, coherent manner while delivering use activities through a simple, consistent, and intuitive interface within each application and across applications. The software architecture may also be reusable, providing plug-in capability to any number of applications without extensive reprogramming, which may enable parties outside of the system 100 to create components that plug into the software architecture. This makes software or portals in the architecture extensible and enables the creation of new software or portals for the architecture by any party.

The software module 106 may also include financial and site planning/progress software applications accessible to the users, such as different users associated with a user or a financial institution to perform one or more functions. The software module 106 in the system 100 may provide the financial and site planning/progress software applications at the same location as the users or a remote location. Each financial and site planning/progress software application may provide a graphical user interface (GUI) for ease of interaction by the users with information resident in the system 100. The GUI may be specific based on the type of user or may be the same for all users or a selected subset of the users.

In addition, the software module 106 may also include a system software to provide a master GUI set that allows the users to select or interact with GUIs of one or more other applications or that allows the users to simultaneously access a variety of information otherwise available through any portion of the system 100. The system software may be a portal or a system as a service (SaaS) that provides, via the GUI, remote access to and from the system 100 for implementing an enhancement. The system software may include, for example, a network browser as well as other standard applications. The system software may also include the ability, either automatically based upon a user request in another application or by a user request, to search or otherwise retrieve data from one or more remote points, such as on the Internet or from a limited or restricted database. The system software may vary by user type or may be available to only a certain user type, depending on the needs of the system 100. The users may have some portions, or all the application software reside on a local computing device, or may simply have linking mechanisms, as understood by those skilled in the art, to link a computing device to the software running on a central server via the communications network, for example. As such, any device having or having access to the system software may be capable of uploading or downloading any information item, data collection item, or informational files associated with such files. Presentation of the data through the software may be in any sort and number of selectable formats. In an exemplary embodiment, a multi-layer format may be used, wherein the additional information is available by viewing successively lower layers of presented information. Such layers may be made available by use of drop-down menus, tabbed folder files, or other layering techniques understood by those skilled in the art or through a novel natural language interface as described herein throughout.

In one embodiment, the storage module 108 may store one or more instructions and data. The data may be related to at least but not limited to agreement between lender and buyer, agreement, lien documents, or agreement security documents. One or more instructions may be instructions that are executable by the processor 114 to perform a specific operation. Some of the commonly known storage implementations may include but are not limited to, fixed (hard) drives, magnetic tape, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g., Microsoft Azure and Amazon Web Services, AWS), or other types of media/machine-readable medium suitable for storing electronic instructions.

In one embodiment, one or more databases 110 may be configured to store a systematic collection of data used for electronic storage and manipulation of data. In one embodiment, the one or more databases 110 may be of various types, such as but not limited to a centralized database, cloud database, and network database. The one or more databases 110 may include structured data containing details of the users, including the lender or the borrower, and all other documents related to their agreement. For example, one or more databases 110 may include the name and address of the lender and borrower, and agreement terms and/or conditions between the lender and the borrower. There are no limitations to the number, type, or connectivity of the one or more databases 110 utilized by the system 100.

The network interface module 112 may perform signal transmission and distribution functions within the system 100. For example, the network interface module 112 may connect electronic devices to electrical systems at the control level. Further, the network interface module 112 may provide many solutions tailored for virtual network deployment and management. For example, the network interface module 112 may efficiently optimize the distribution and management of virtual workloads and provide maximum scalability, reduced bottleneck impediments. Further, the network interface module 112 may be easily integrated into existing hardware and architecture and configured to deploy virtual machine device queues. Further, the network interface module 112 may be ideally suited for the consolidation of virtual network traffic. Processor 114 may be implemented as one or more microprocessors, microcontrollers, digital signal processors, central processing units, logic circuitries, or any devices that can manipulate data based on one or more instructions stored in the storage module 108. In one case, the processor 114 may manipulate data received from one or more databases 110. In another case, the processor 114 may manipulate data stored in the storage module 108.

The system 100 may further comprise a network 116 to enable communication between the processing system 102 and the one or more computing devices 118-1 . . . 118-N. Additionally, the system 100 may utilize any conventional operating platform or combination of platforms (Windows, Mac OS, Unix, Linux, Android, etc.) and may utilize any conventional networking and communications software as would be understood by those skilled in the art. The network 116 can be a wide area network and may be any suitable networked system understood by those having ordinary skill in the art, such as, for example, an open, wide area network (e.g., the Internet), an electronic network, an optical network, a wireless network, a physically secure network or virtual private network, and any combinations thereof. The network 116 may also include any intermediate nodes, such as gateways, routers, bridges, Internet service provider networks, public-switched telephone networks, proxy servers, firewalls, and the like, such that the network may be suitable for the transmission of information items and other data throughout the system 100. The network 116 may also use standard architecture and protocols as understood by those skilled in the art, such as, for example, a packet-switched network for transporting information and packets in accordance with a standard transmission control protocol/Internet protocol (“TCP/IP”).

The system 100 may use an encryption standard to protect data from unauthorized interception over the network 116. The data may be sensitive user financial and personal identification data, government data related to the construction or site plans, other confidential data, and compliance with state and federal laws pertaining to the protection of financial and personal identification data. Further, the system 100 may use any encryption standard or authentication method as may be understood by those having ordinary skill in the art at any point in time. For example, the encryption standard may encrypt an output file using a secure socket layer (SSL) with dual key encryption in an exemplary embodiment. Additionally, the system 100 may limit data manipulation or information access. In an exemplary embodiment, the system administrator may allow for administration of the system at one or more levels, such as at an individual reviewer, a review team manager, a quality control review manager, or a system manager. The system administrator may also implement access or use restrictions for the users at any level. In an exemplary embodiment, the restrictions may include, for example, the assignment of usernames and passwords required for the use of the system 100, run a check for or to implement an enhancement, backend administrative access, associated mobile device apps, or the selection of one or more data types that the user is allowed to view or manipulate.

The one or more computing devices 118-1 . . . 118-N may be coupled to the network 116 and configured to be used by the system administrator, or the users such as contractors, borrowers, and auxiliary users such as but not limited to financial institutions and underwriters. Therefore, it can be noted that one or more computing devices 118-1 . . . 118-N may be referred to as a computing device 118, hereinafter.

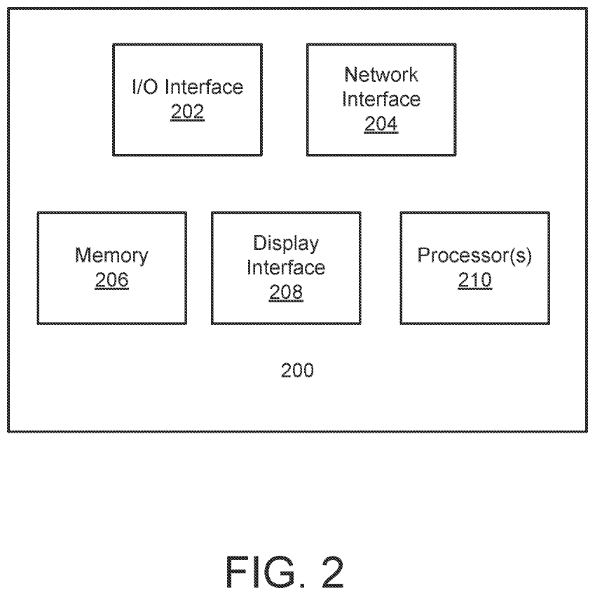

In one embodiment, the computing device 118 may be a central processing server, it may be one server or, more preferably, a combination of scalable servers, providing functionality as a network mainframe server, a web server, a mail server, and central database server, all maintained and managed by the system administrator or operator of the system. Further, the computing device 118 may be connected directly or via a network to remote databases, such as for additional storage backup, to allow communication of files, email, software, and any other data formats between two or more computing devices, such as between a user's mobile device, stakeholder systems, lender systems, and financial institution platforms. It can be noted that the block diagram of the computing device 118 of the system 100 is explained in FIG. 2.

FIG. 2 illustrates a block diagram of a computing device that communicates with a computer that tracks compliance with terms of a financial agreement. Computing device 200 may be a computing device 118 of FIG. 1. that may be a desktop computer, a mobile device, a laptop, a tablet computer, a smartphone/other wireless digital/cellular phone, or a thin client device as would be understood by those skilled in the art. In an exemplary embodiment, the operable computer components of the system 100 for determining and implementing an enhancement may reside entirely on a single computing device or a central server and run on any number of end-user devices via the network 116. In one exemplary embodiment, the users may run an application or program on their mobile devices so that the system 100 can be easily accessed in real-time at a construction site. In one embodiment, the computing device 118 may include at least one processor, standard input and output devices, as well as all hardware and software for storing data and running programs, and for sending and receiving data over a network 116. For example, the computing device 118 may comprise an input and output (I/O) interface 202, a network interface 204, memory 206, a display interface 208, and at least one processor 210.

A user may use the I/O interface 202 to provide information for utilizing a mechanic's lien for enhancing payment performance on an agreement. The I/O interface 108 may comprise I/O devices, display devices, or a group of devices may be augmented reality devices. The I/O devices may be controlled by an I/O controller. The I/O controller may control one or more I/O devices, such as e.g., a keyboard and a pointing device, e.g., a mouse or optical pen. Furthermore, an I/O device may also allow storage and/or an installation medium for the computing device. In still other embodiments, the computing device 118 may allow USB connections (not shown) to receive handheld USB storage devices. In further embodiments, an I/O device may be a bridge between a system bus and an external communication bus, e.g., a USB bus, a SCSI bus, a FireWire bus, an Ethernet bus, a Gigabit Ethernet bus, a Fiber Channel bus, or a Thunderbolt bus.

The network interface 204 may for ease of interaction by the user with information resident in the system 100 and for facilitating communication of the computing device 118 with the network 116. The network interface 204 may be specific to a user, set of users, or type of user, or may be the same for all users or a selected subset of users. The system software may also provide a master network interface 204 set that allows a user to select or interact with the network interface 204 of one or more other applications, or that allows a user to simultaneously access a variety of information otherwise available through any portion of the system. Further, the network interface 204 may perform signal transmission and distribution functions within the computing device 118.

The memory 206 may be used to store data related to the borrower, the credit history, and the current credit of the borrower or the user. Further, the memory 206 may be configured to store a systematic collection of data used for electronic storage and data manipulation. In one embodiment, the database may be of various types, such as but not limited to a centralized database, cloud database, and network database. The memory 206 may include structured data containing details of the users, including the lender or the borrower, and all other documents related to their agreement. In an embodiment, the memory 206 may include the name and address of the lender and borrower, agreement terms and conditions between the lender and the borrower. There are no limitations to the number, type, or connectivity of the memory 206 utilized by the computing device 118.

The display interface 208 may correspond to output devices including, but not limited to, video displays, graphical displays, speakers, headphones, inkjet printers, laser printers, and 3D printers. In another embodiment, the display interface 208 may correspond to an input/output device like a touch screen, capable of receiving user input. Further, the display interface 208 may be a user device graphical user interface (GUI) or guided user interface(s) that may either accept users' inputs or facilitate outputs to the users or perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may be implemented as a Command Line Interface (CLI), a GUI, a voice interface, or a web-based user interface. For example, the display interface 208 may facilitate users to input data related to credit offers and project information. In one embodiment, the display interface 208 may send notifications in a user-friendly or interactive form to the user.

At least one processor 210 may perform the operations run by the memory 206. In one embodiment, at least one processor 210 may be a digital signal controller (DSC) for processing the signals received during the method of adjusting the credit offer. The DSC may be a hybrid of microcontrollers and digital signal processors (DSPs). In another embodiment, at least one processor 210 may be a microcontroller to process the control signals received during the adjustment of the credit offer. At least one processor 210 may be manufactured by different manufacturers such as Microchip, Freescale, and Texas Instruments.

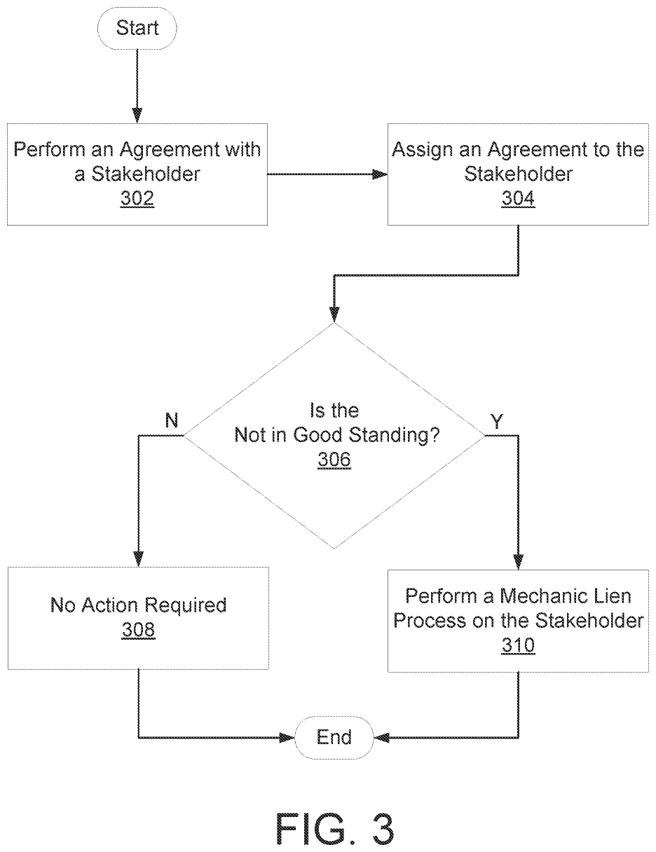

FIG. 3 illustrates a flow chart showing a working method for utilizing the mechanic's lien to enhance payment performance on the agreement. It should also be noted that in some alternative implementations, the functions noted in the blocks may occur out of order noted in the drawings. For example, two blocks shown in succession in FIG. 3 may be executed substantially concurrently, or the blocks may sometimes be executed in the reverse order, depending upon the functionality involved. In addition, the process descriptions or blocks in flow charts should be understood as representing decisions made by a hardware structure such as a state machine. For example, the flowchart of FIG. 3 starts at step 302 and proceeds to step 310.

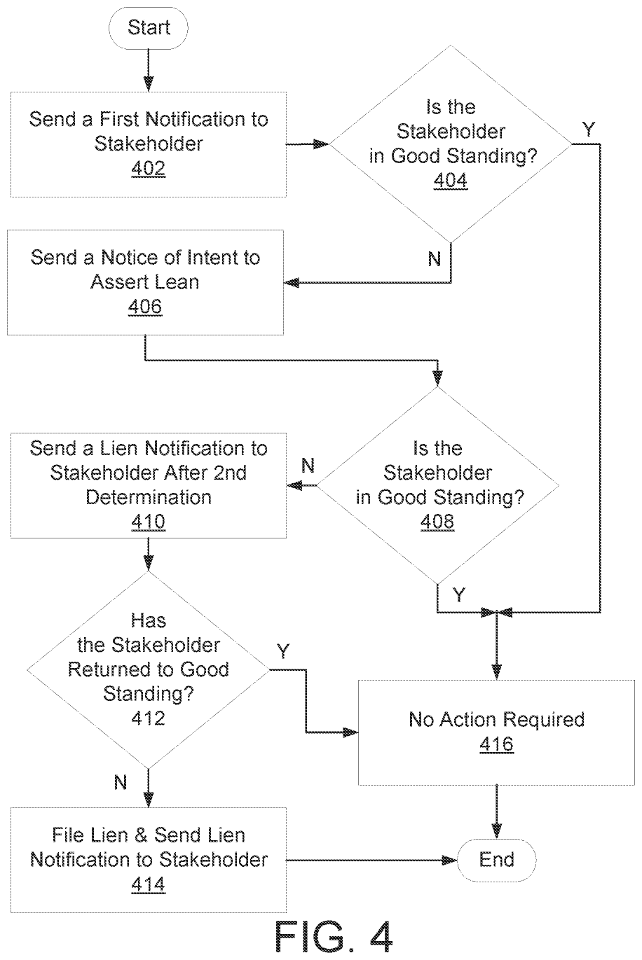

At first, an agreement may be performed with a stakeholder, at step 302. In one exemplary embodiment, a retail installment agreement is made between the lender—Mark, and the borrower—Alex, where Mark is lending a agreement of $10,00,000 to Alex for purchasing construction material on a construction project on 51 Queens Avenue, New York. Successively, an agreement may be assigned to the stakeholder based on the agreement, at step 304. For example, in one exemplary embodiment, Mark provides an agreement of $10,00,000 to Alex based on the retail installment agreement. For example, a “retail installment agreement” or an “agreement” is a contract between two parties whereby money is used to buy materials by a first party and where payments are made by a second party to the first party overtime to pay the first party the total amount plus interest. Successively, a determination may be made as if the stakeholder is not in good standing at step 306. For example, good standing means that any related party payments have been paid for the correct amount and at the correct time. Good standing could also mean a “standing ratio” is met, for instance, the payments that have been made to date are for example greater than 75% of the overall payment. So a payer that has a high standing ratio may be considered in good standing. For example, good standing could also mean meeting a legal deadline. For example, a “legal deadline” is a trigger for filing a lien. For example, a determination is made if Alex has repaid the agreement to Mark. The determination as to whether the stakeholder is not in good standing can be provided, for example, by data made available from an underwriter or a financial institution. In addition, the good standing may disclose whether the stakeholder is in default or delinquent on payments. In one case, when the stakeholder may be in good standing, no action is required at step 308. In one exemplary embodiment, the stakeholder is in good standing only if the account has been approved for funding and the stakeholder complies with the retail installment agreement. In one embodiment, when the stakeholder is in good standing, a mechanic lien may still be implemented to maintain and encourage future payment performance. In another case, when the stakeholder may not be in good standing, the mechanic's lien process may be performed on the stakeholder at step 310. In one exemplary embodiment, the stakeholder is not in good standing only if the stakeholder is not in compliance with the retail installment agreement, i.e., Alex has not repaid Mark with the agreement of $10,00,000. The mechanic lien process may be explained in conjunction with FIG. 4A and FIG. 4B.

FIG. 4 illustrates a series of steps that may be performed by a computer that manages compliance with a financial agreement and that issues mechanics liens when stakeholder are not in compliance with their financial agreement. The mechanic lien process of FIG. 4 may start by sending the first notification to the stakeholder at step 402. It can be noted that the first notification may include details such as but not limited to the title of the company or financial institution and agreement detail. In an exemplary embodiment, an email notification is sent to Alex, with details of XYZ company bound to pay Mark an amount of $10,00,000. Successively, if the stakeholder is in good standing, a first determination may be performed at step 404. For example, the system 100 determines if Alex has repaid the agreement of $10,00,000 to Mark.

In one case, when the stakeholder is not in good standing, a notice of intent to lien to the stakeholder may be sent at step 406 based on the first determination. It can be noted that a written notification to the Division that an activity or discharge is intended to be covered by a general permit is sent to the stakeholder. In an exemplary embodiment, if Alex has not repaid the $10,00,000 to Mark, a notice of intent to lien is sent to Alex. Further, if the stakeholder is in good standing, a second determination may be performed at step 408. For example, the system 100 determines if Alex has repaid the agreement of $10,00,000 to Mark. In one case, when the stakeholder is not in good standing, a lien notification may be sent to the stakeholder at step 410 based on the second determination. In an exemplary embodiment, a notice is sent to notify Alex of the consequences of nonpayment, like an added fine of $5000. It can be noted that the lien notification may be a warning that if payment isn't made, the lender intends to file a mechanics lien. Further, if the stakeholder is in good standing, a third determination may be performed at step 412. For example, the system 100 determines if Alex has repaid the agreement of $10,00,000 to Mark. In one case, when the stakeholder is not in good standing, the lien may be filed, and notification to the stakeholder may be sent at step 414, based on the third determination. In an exemplary embodiment, a lien is filed, and a notification is sent to Alex of the consequences of nonpayment, like an added fine of $5000. In another case, when the stakeholder is in good standing, no action may be required at step 416. Further, at steps 404 and 408, no action may be required when the stakeholder is in good standing, and the system 100 moves to step 416 to end the process.

The system and method for utilizing a lien to implement an enhancement may also include standard reporting mechanisms that may enhance payment performance on an agreement by instituting an automatic system for triggering a mechanic's lien process, thereby driving payment on the underlying agreement. The system and method for utilizing a lien to implement an enhancement may also include standard reporting mechanisms, such as generating a printable receipt of the transaction or electronic results report that can be transmitted to any communicatively connected computing device, such as a generated email message or file attachment. Likewise, particular results of the system transaction can trigger an alert signal, such as the generation of an alert email, text, or phone call, to alert a user, financial institution, or person associated with the user or financial institution.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for identifying financial compliance, the method comprising:
comparing payment data with payment completed data to identify whether a financial agreement between a first entity and a stakeholder is being adhered to;
identifying that the financial agreement has not been adhered to based on comparison of the payment data with the payment completed data indicating that the stakeholder has not adhered to a term of the financial agreement;
generating a first notification indicating that a status of the stakeholder is not in good standing to send to the stakeholder based on the identification that the financial agreement has not been adhered to, wherein the first notification is sent to the stakeholder informing the stakeholder that they are not in good standing;
performing an evaluation to indicating that the stakeholder is still not in good standing; and
generating a second notification indicating that a lien will be applied according to the financial agreement based on the evaluation indicating that the stakeholder is still not in good standing, wherein the second notification is sent indicating that the lean will be applied according to the financial agreement based on the evaluation indicating that the stakeholder is still not in good standing.

2. The method of claim 1, further comprising performing a calculation to identify whether the financial agreement has been adhered to, the calculation associated with identifying whether the payment completed data identifies whether that the stakeholder has at least met a minimum percentage of a total of overall payments.

3. The method of claim 2, further comprising receiving data that identifies the minimum percentage of the total of overall payments and storing that data in database.

4. The method of claim 2, wherein the calculation includes:
identifying a total value of all previous due payments associated with the financial agreement;
summing all payments received that service the financial agreement; and
dividing the value of the previous due payments by the sum of the received payments.

5. The method of claim 2, further comprising identifying that the stakeholder has not met the minimum percentage of overall payments.

6. The method of claim 5, further comprising initiating a lien associated with the financial agreement based on the indication that the stake holder is still not in good standing.

7. The method of claim 1, further comprising identifying that the stakeholder has made a payment that brings the stakeholder in compliance with terms of the financial agreement.

8. A non-transitory computer-readable storage medium having embodied thereon a program executable by a processor for implementing a method for identifying financial compliance, the method comprising:
comparing payment data with payment completed data to identify whether a financial agreement between a first entity and a stakeholder is being adhered to;
identifying that the financial agreement has not been adhered to based on comparison of the payment data with the payment completed data indicating that the stakeholder has not adhered to a term of the financial agreement;
generating a first notification indicating that a status of the stakeholder is not in good standing to send to the stakeholder based on the identification that the financial agreement has not been adhered to, wherein the first notification is sent to the stakeholder informing the stakeholder that they are not in good standing;
performing an evaluation to indicating that the stakeholder is still not in good standing; and
generating a second notification indicating that a lien will be applied according to the financial agreement based on the evaluation indicating that the stakeholder is still not in good standing, wherein the second notification is sent indicating that the lean will be applied according to the financial agreement based on the evaluation indicating that the stakeholder is still not in good standing.

9. The non-transitory computer-readable storage medium of claim 8, the program further executable to perform a calculation to identify whether the financial agreement has been adhered to, the calculation associated with identifying whether the payment completed data identifies whether that the stakeholder has at least met a minimum percentage of a total of overall payments.

10. The non-transitory computer-readable storage medium of claim 9, the program further executable to receive data that identifies the minimum percentage of the total of overall payments and storing that data in database.

11. The non-transitory computer-readable storage medium of claim 9, wherein the calculation includes:
identifying a total value of all previous due payments associated with the financial agreement;
summing all payments received that service the financial agreement; and
dividing the value of the previous due payments by the sum of the received payments.

12. The non-transitory computer-readable storage medium of claim 9, the program further executable to identify that the stakeholder has not met the minimum percentage of overall payments.

13. The non-transitory computer-readable storage medium of claim 12, the program further executable to initiate a lien associated with the financial agreement based on the indication that the stake holder is still not in good standing.

14. The non-transitory computer-readable storage medium of claim 8, the program further executable to identify that the stakeholder has made a payment that brings the stakeholder in compliance with terms of the financial agreement.

15. An apparatus for identifying financial compliance, the apparatus comprising:
a memory;
a processor that executes instructions out of the memory to:
compare payment data with payment completed data to identify whether a financial agreement between a first entity and a stakeholder is being adhered to,
identify that the financial agreement has not been adhered to based on comparison of the payment data with the payment completed data indicating that the stakeholder has not adhered to a term of the financial agreement,
generate a first notification indicating that a status of the stakeholder is not in good standing to send to the stakeholder based on the identification that the financial agreement has not been adhered to, wherein the first notification is sent to the stakeholder informing the stakeholder that they are not in good standing,
perform an evaluation to indicating that the stakeholder is still not in good standing, and
generate a second notification indicating that a lien will be applied according to the financial agreement based on the evaluation indicating that the stakeholder is still not in good standing, wherein the second notification is sent indicating that the lean will be applied according to the financial agreement based on the evaluation indicating that the stakeholder is still not in good standing.

16. The apparatus of claim 15, wherein a calculation is performed to identify whether the financial agreement has been adhered to, the calculation associated with identifying whether the payment completed data identifies whether that the stakeholder has at least met a minimum percentage of a total of overall payments.

17. The apparatus of claim 16, wherein data is received that identifies the minimum percentage of the total of overall payments and storing that data in database.

18. The apparatus of claim 16, wherein the calculation includes:
identifying a total value of all previous due payments associated with the financial agreement;
summing all payments received that service the financial agreement; and
dividing the value of the previous due payments by the sum of the received payments.

19. The apparatus of claim 16, wherein an identification is made that the stakeholder has not met the minimum percentage of overall payments.

20. The apparatus of claim 19, wherein a lien associated with the financial agreement is initiated based on the indication that the stake holder is still not in good standing.
